(19) United States
(12) Patent Application Publication
(10) Pub. No.: US 2019/0281858 A1
(43) Pub. Date: Sep. 19, 2019

(54) FOOD PREPARATION SYSTEM AND METHOD OF USE

(71) Applicant: Sean Saeyong Kim, Arlington, TX (US)

(72) Inventor: Sean Saeyong Kim, Arlington, TX (US)

(21) Appl. No.: 16/182,125

(22) Filed: Nov. 6, 2018

Related U.S. Application Data
(60) Provisional application No. 62/642,459, filed on Mar. 13, 2018.

(51) Int. Cl. A23G 9/22; A23G 9/08; A23L 3/36; F25C 1/04; F25C 1/22; F25C 5/04

(52) U.S. Cl. CPC A23G 9/228; A23G 9/083; A23G 9/221; A23L 3/364; F25C 2600/04; F25C 1/22; F25C 5/04; A23V 2002/00; F25C 1/04

(57) ABSTRACT

A food preparation system that can simultaneously freeze and shape liquids quickly and has a plurality of integral walls forming a cavity that may be used as a freezing surface, a removable tray that fits inside the cavity, a plurality of shaped freezing surfaces located on the tray, a top surface forming one of the integral walls which is used as a flash-freezing surface, a front panel interface forming one of the integral walls, and a plurality of control buttons located on the front panel interface which control the food preparation system.

### BACKGROUND

### 1. Field of the Invention

The present invention relates generally to food preparation systems and methods of use. More specifically, the invention is related to a system and method to freeze items into a shape on every face using a cooling device.

### 2. Description of Related Art

Systems and methods for freezing goods is well known in the art. At times, it is required to quickly freeze items in small quantities. For example, retail stores are selling items such as liquid nitrogen freezing mixers, anti-griddles, and other similar items related to freezing.

One of the problems commonly associated with freezing systems is the limited use. For example, current methods only allow for two-dimensional preparation, require significant time to freeze larger items, and lose energy to cooling the air. Additionally, current freezing and shaping methods are very time-consuming, even for small shaped objects like cubes.

Although great strides have been made in the area of freezing, many shortcomings remain.

### DESCRIPTION OF THE DRAWINGS

The novel features believed characteristic of the embodiments of the present application are set forth in the appended claims. However, the embodiments themselves, as well as a preferred mode of use, and further objectives and advantages thereof, will best be understood by reference to the following detailed description when read in conjunction with the accompanying drawings, wherein:

FIG. 1 is a simplified schematic of a system and method of the present invention in accordance with the preferred embodiment of the present invention;

FIG. 2 is a side view of the freezing system shown in FIG. 1;

FIG. 3 is a top view of the freezing system shown in FIG. 1;

FIG. 4 is the top view of a contemplated embodiment of the tray configuration for the freezing system shown in FIG. 1; and

FIG. 5 is the top view of an alternative tray for the freezing system shown in FIG. 1;

While the system and method of use of the present application is susceptible to various modifications and alternative forms, specific embodiments thereof have been shown by way of example in the drawings and are herein described in detail. It should be understood, however, that the description herein of specific embodiments is not intended to limit the invention to the particular embodiment disclosed, but on the contrary, the intention is to cover all modifications, equivalents, and alternatives falling within the spirit and scope of the present application as defined by the appended claims.

### DETAILED DESCRIPTION OF THE PREFERRED EMBODIMENT

Illustrative embodiments of the system and method of use of the present application are provided below. It will of course be appreciated that in the development of any actual embodiment, numerous implementation-specific decisions will be made to achieve the developer's specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

The system and method of use in accordance with the present application overcomes one or more of the above-discussed problems commonly associated with conventional systems and methods to freeze goods. Specifically, the present invention is a tool to shape a liquid while it dries, hardens or freezes. These and other unique features of the system and method of use are discussed below and illustrated in the accompanying drawings.

The system and method of use will be understood, both as to its structure and operation, from the accompanying drawings, taken in conjunction with the accompanying description. Several embodiments of the system are presented herein. It should be understood that various components, parts, and features of the different embodiments may be combined together and/or interchanged with one another, all of which are within the scope of the present application, even though not all variations and particular embodiments are shown in the drawings. It should also be understood that the mixing and matching of features, elements, and/or functions between various embodiments is expressly contemplated herein so that one of ordinary skill in the art would appreciate from this disclosure that the features, elements, and/or functions of one embodiment may be incorporated into another embodiment as appropriate, unless described otherwise.

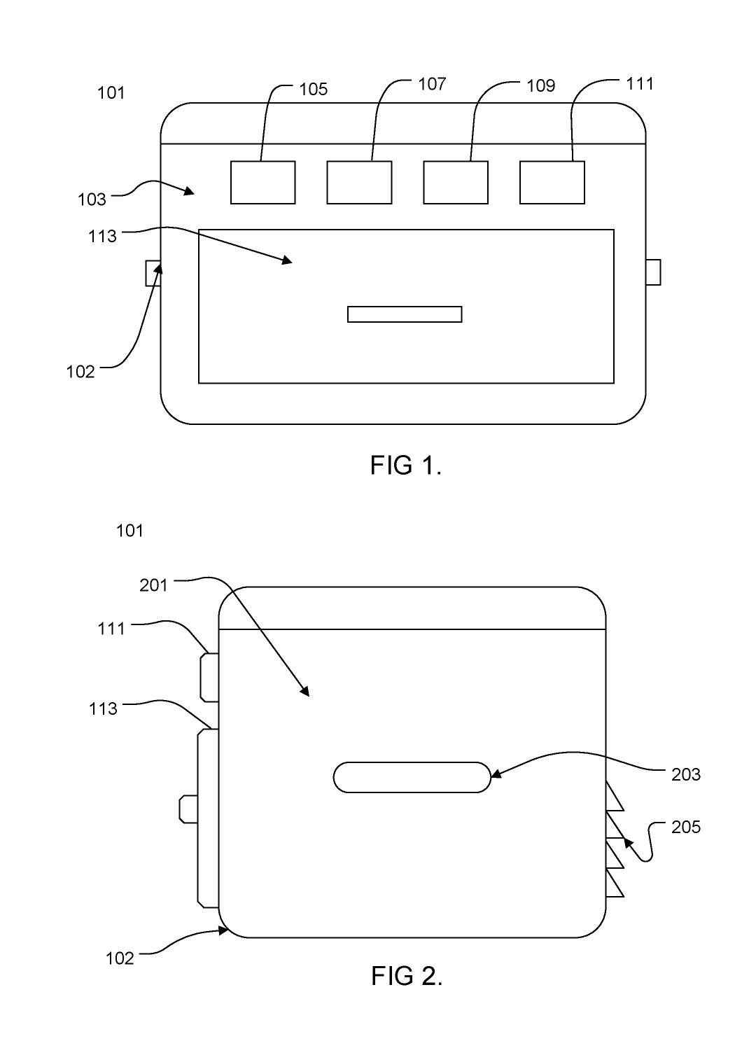

Referring now to the drawings wherein like reference characters identify corresponding or similar elements throughout the several views, FIGS. 1-3 depict various views of a system and method of use in accordance with a preferred embodiment of the present application. It will be appreciated that system overcomes one or more of the above-listed problems commonly associated with the conventional systems and methods to freeze goods.

In the contemplated embodiment, the system 101 utilizes a container 102 with a freezing surface on top and a plurality of trays configured to overcome the problems commonly associated with conventional freezing processes.

Referring now to FIG. 1, a simplified schematic of the present invention is depicted with the front-interface 103 having a control panel with control buttons 105, 107, 109, 111, e.g. temperature control. Additionally, the front interface 103 is shown having a front panel 113 that can be rotated downward to expose a hollow cavity inside the system. The hollow cavity is configured to hold a removable tray that can be slid in and out of the freezing apparatus. The removable tray is configured to be on a track that allows it to slide perpendicular to the cavity opening as well as rotate once it has been extended outwards. The removable tray is has a handle connected to the front for ease of removal from the inner cavity. FIG. 1 is also shown having two side handles integrally connected to two opposing side walls.

In FIG. 2, a side view of system 101, an integral side wall 201 of the container 102 is shown having a handle 203 long enough to grip. The back is shown having vents 205. FIG. 2 also shows the enclosed form of the invention and is representative of both sides in this embodiment.

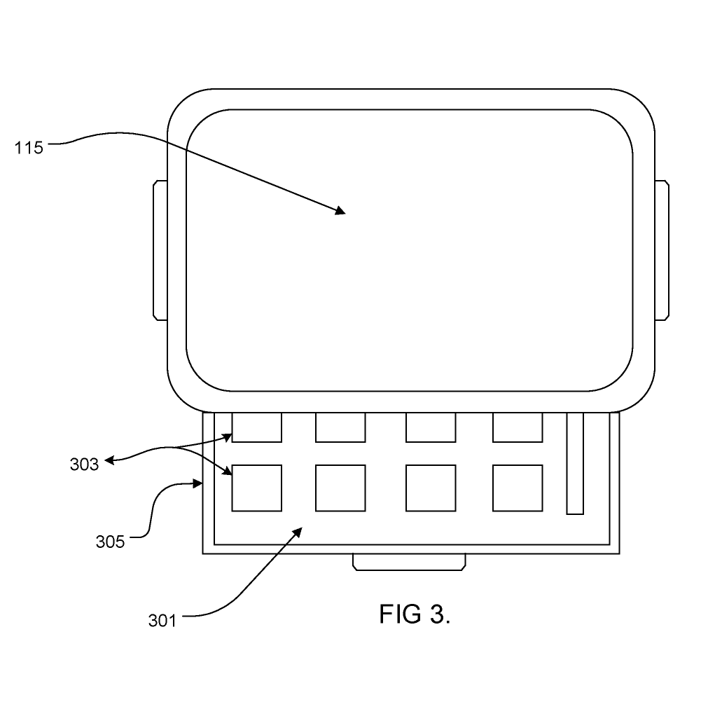

Referring now to FIG. 3, the top view of the freezing apparatus is shown having a body with a plurality of integral walls and a top surface. One wall includes a drawer 305 that encloses a tray 301 in which the items are to be frozen. On the top is shown a freezing surface 115. Two handles, one on each side and opposing each other, are shown.

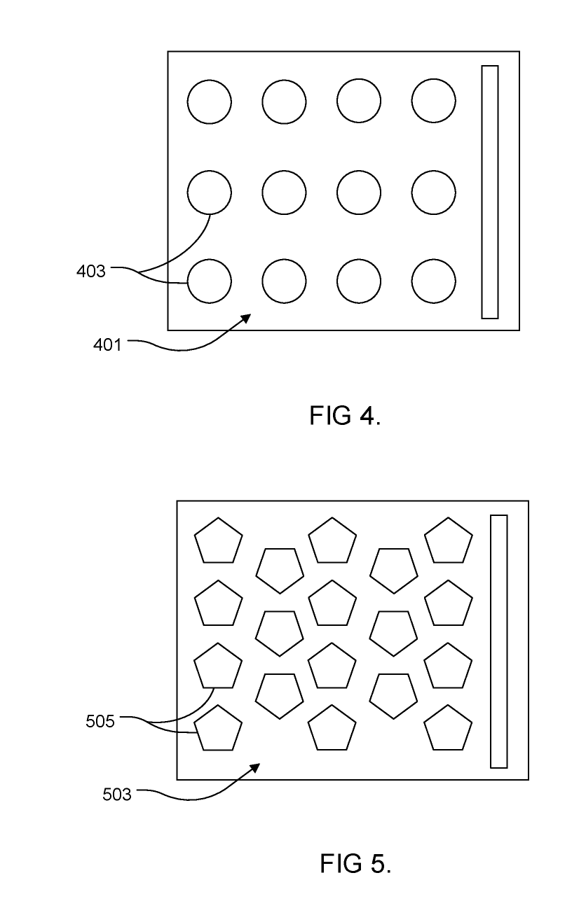

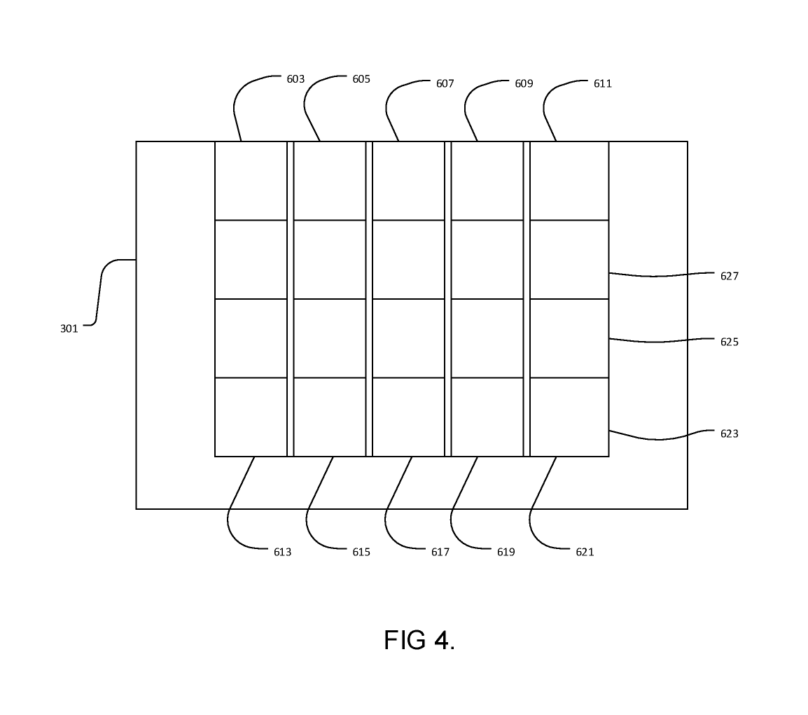

Referring now to FIGS. 4 and 5, the tray 301 is shown with two possible configurations 401, 501 and shapes 403, 503. It is contemplated that the tray may house a plurality of freezing surfaces that may be configured to freeze liquids in any reasonable three-dimensional object including but not limited to cubes, prisms, cylinders, stars, etc. A slot in the same plane as the tray indentations is shown as an interface between the top of the cavity and the tray itself.

In one contemplated embodiment, the freezing apparatus has a freezing surface on top as well as freezing surfaces inside. However, it should be understood that the apparatus may have many other functions attached, e.g., utensil holder or a tray that embodies the whole drawer. The freezing apparatus is configured to freeze and shape liquids simultaneously and in a very short amount of time. In one test, the liquid was frozen and shaped in as little as 3-5 minutes. This is a significant advantage to many other conventional freezing and shaping methods.

In another contemplated embodiment, the apparatus may be used to shape liquids during a hardening process that does not involve freezing.

In an alternate embodiment, the present invention may be a stationary machine, similar to a conventional oven in a household or commercial kitchen. The stationary machine would be configured to quickly freeze and mold liquids into specific shapes.

Referring now to FIG. 6, an alternate embodiment of the present invention is shown wherein the freezing surfaces forming shapes such as 403, 503 are configured as a plurality of elongated columns 603-611. The tray 301 has a much greater thickness in order to fully house the full depth of the elongated columns. Each column 603-611 may be further divided into a series of rows 623-627. Each row within the column may be compartmentalized such that each molding area is not contaminated by the molding areas located above or below.

In one configuration, the liquid may be poured from the top to fill the columns. In a further configuration, the liquid may be poured from the bottom to fill the columns. In either case, as each molding area is filled, a divider can be slid or snapped into place before filling the next molding area. Additionally, the bottom closure of each column is designed as a flat sheet in the shape of the column and is configured to be a piston head 613-621. The piston, in the shape of the mold, will allow each compartmentalized section to be molded from top to bottom and allows each column of liquid to be easily ejected when the molding is finished. The piston head is designed to slide vertically through each column.

The particular embodiments disclosed above are illustrative only, as the embodiments may be modified and practiced in different but equivalent manners apparent to those skilled in the art having the benefit of the teachings herein. It is therefore evident that the particular embodiments disclosed above may be altered or modified, and all such variations are considered within the scope and spirit of the application. Accordingly, the protection sought herein is as set forth in the description. Although the present embodiments are shown above, they are not limited to just these embodiments, but are amenable to various changes and modifications without departing from the spirit thereof.

What is claimed is:

1. A food preparation system comprising:
a plurality of integral walls forming a cavity therein;
wherein the cavity is configured as a freezing apparatus;
a removable tray configured to fit inside the cavity;
a plurality of shaped freezing surfaces located on the tray;
a top surface forming one of the integral walls which is configured as a flash-freezing surface;
a front panel interface forming one of the integral walls; and
a plurality of control buttons located on the front panel interface configured to control the food preparation system;
wherein the food preparation system is configured to simultaneously freeze and shape liquids quickly into three-dimensional objects.

2. The food preparation system of claim 1, wherein the liquids are simultaneously shaped and frozen within three to five minutes.

3. The food preparation system of claim 1, wherein the plurality of control buttons are configured to:
control a power source to the food preparation system;
control the temperature of the cavity and the freezing surface located on the top surface; and
control a length of time that the liquids are subjected to freezing conditions.

4. The food preparation system of claim 1, wherein the freezing surfaces located on the removable tray are configured to shape the liquids as cubes.

5. The food preparation system of claim 1, wherein the plurality of control buttons are configured to allow the food preparation system to shape and harden the liquids without freezing conditions.

6. The food preparation system of claim 1, wherein the plurality of shaped freezing surfaces is configured as elongated columns.

7. The food preparation system of claim 6, further comprising:
a base sheet located at the bottom of each elongated column;
wherein the base sheet is configured as a piston head that allows a molded liquid to be ejected from the column.

8. The food preparation system of claim 6, wherein the elongated columns further comprise:
a plurality of rows configured as compartmentalized molding areas.
